(19) United States
(12) Patent Application Publication
(10) Pub. No.: US 2024/0244109 A1
(43) Pub. Date: Jul. 18, 2024

(54) MINIMAL REAL-WORLD REQUIREMENTS FOR METAVERSE APPLICATIONS

(71) Applicant: Cisco Technology, Inc., San Jose, CA (US)

(72) Inventors: Pete Rai, Surrey (GB); Joel Abraham Obstfeld, Hertfordshire (GB); Simon Peter James Dyke, Hampshire (GB); James Geoffrey Walker, West Sussex (GB)

(21) Appl. No.: 18/153,501

(22) Filed: Jan. 12, 2023

(51) Int. Cl. H04L 67/131; G06F 3/01

(52) U.S. Cl. CPC H04L 67/131; G06F 3/011

(57) ABSTRACT

Methods that determine whether real-world conditions are satisfied for a metaverse application and/or a feature of the metaverse application. The methods involve obtaining information about a real-world environment of a user that is interacting within a metaverse environment. The information includes at least one of one or more attributes of the user in the real-world environment or one or more characteristics of a physical space of the user in the real-world environment. The methods further involve determining whether the information about the real-world environment satisfies a policy associated with a metaverse application, where the policy defines one or more real-world conditions for the metaverse application and configuring the metaverse environment based on determining whether the information about the real-world environment satisfies the policy.

### TECHNICAL FIELD

The present disclosure generally relates to virtual environments.

### BACKGROUND

Metaverse is an evolution of the Internet. In metaverse, humans interact “within” or are immersed into a virtual environmental. Virtual environments enable immersive experiences for their users utilizing techniques such as augmented, mixed, and virtual reality, through a range of human-to-machine interface methods including headsets, microphones and headphones, haptic feedback solutions, etc. Some virtual environments are intended to mimic interactions that would take place in the physical world. Other virtual environments may create interactions within a fantasy world where different laws of physics may apply. By using these technologies, users interact with each other and use a range of services, regardless of geographical location or physical capability. For some metaverse applications, it may be desirable to set specific or restrictive real-world conditions before allowing a user to access, use, or participate within the virtual environment.

### BRIEF DESCRIPTION OF THE DRAWINGS

FIG. 1 is a block diagram illustrating a metaverse system which includes a policing agent that determines whether real-world requirements are satisfied for a metaverse application based on one or more policies, according to an example embodiment.

FIG. 2 is a view illustrating a policy that defines real-world conditions associated with a metaverse application, according to an example embodiment.

FIG. 3 is a sequence diagram illustrating a method of determining whether real-world environment satisfies a policy for installing a metaverse application, according to an example embodiment.

FIG. 4 is a sequence diagram illustrating a method of determining whether real-world environment satisfies a policy for executing a metaverse application, according to an example embodiment.

FIG. 5 is a sequence diagram illustrating a method of determining whether real-world environment satisfies a policy for enabling or disabling one or more features in a running instance of a metaverse application, according to an example embodiment.

FIG. 6 is a flowchart of a method for configuring a metaverse environment based on whether information about the real-world environment of a user satisfies a policy, according to an example embodiment.

FIG. 7 is a hardware block diagram of a computing device that may perform functions associated with any combination of operations in connection with the techniques depicted and described in FIGS. 1-6, according to various example embodiments.

### DETAILED DESCRIPTION

### Overview

Techniques are presented herein determine whether real-world conditions of a user that is interacting within a metaverse environment satisfies minimum real-world requirements associated with a metaverse application.

In one form, the method involves obtaining information about a real-world environment of a user that is interacting within a metaverse environment. The information includes at least one of one or more attributes of the user in the real-world environment or one or more characteristics of a physical space of the user in the real-world environment. The method further involves determining whether the information about the real-world environment satisfies a policy associated with a metaverse application. The policy defines one or more real-world conditions for the metaverse application. The method further involves configuring the metaverse environment based on determining whether the information about the real-world environment satisfies the policy.

### Example Embodiments

A metaverse environment is a computer-generated and visually rendered environment in which entities are represented with avatars. An avatar may be textual (e.g., username), a two-dimensional graphical representation, a three-dimensional graphical representation, or any other perceivable representation of an entity in the metaverse environment. In this computer-generated environment, a user may perform a medical operation, engage in physical exercise, play a game, etc. Since user interactions are still performed in the real world, which are then translated into the computer-generated environment, some real-world restrictions may be needed for certain metaverse applications. Given the nature of the computer-generated environment, however, it is challenging for service providers (e.g., metaverse application developers) to ensure that their metaverse applications are used in an approved and authorized mode.

For example, a military-grade secure application might require the user to be within room locked with a suitable locking mechanism before the application can be used. A medical application might only execute if the user is physically within health settings (e.g., hospital). Data sovereignty might mean that an application user must be within a specific region or country to use an application's features.

As other examples, a minimal clearance space around a user may be required before the user can use a metaverse application that requires free movement. A metaverse exercise application might need the user to maintain a heart rate below a target level to continue using this application. A financial institution may require their staff to be alone in the room. As such, a metaverse financial application may require that user be alone before the user enters a virtual branch of the financial institution in the virtual environment. A legal firm may need other users (e.g., witnesses) before they can review or attest legal documents, etc. As such, a metaverse legal application may require presence of other users or avatars before the user is presented with legal documents in the virtual environment.

In other words, it may be desirable for entities to define real-world requirements or conditions for metaverse applications such that the entities (e.g., metaverse application owners) can be assured that their metaverse applications are being used in an approved mode e.g., safely and/or securely. The techniques presented herein ensure that minimal real-world conditions associated with a metaverse application and/or its feature are satisfied.

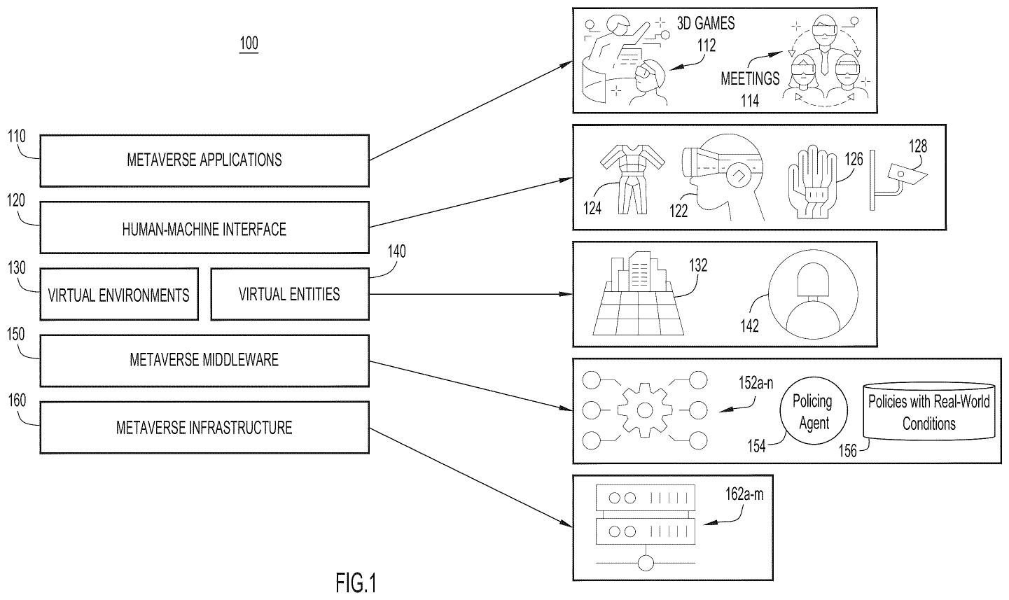

FIG. 1 is a block diagram illustrating a metaverse system 100 which includes a policing agent that determines whether real-world requirements are satisfied for a metaverse application based on one or more policies, according to an example embodiment. The metaverse system 100 includes metaverse applications 110, a human-machine interface 120, virtual environments 130, virtual entities 140, metaverse middleware 150, and a metaverse infrastructure 160.

In the metaverse system 100, the metaverse applications 110 are client applications that immerse one or more users into various digital or virtual spaces referred to as a “virtual environment”. Virtual environments represent a physical world and/or fantasy worlds. Using the metaverse applications 110, users feel as if they are inside a virtual space or environment as opposed to the actual physical world. By way of an example and not by way of a limitation, the metaverse applications 110 may provide 3D games 112 (single or multi-player), online virtual meetings 114 (social or work collaboration spaces), sports, exercises, training, and/or shopping. Some metaverse applications may involve specialized equipment and/or tools e.g., performing a surgery, controlling a drone, etc. There are many different types of metaverse applications 110. Further, metaverse applications 110 provide different user experiences and render different virtual environments within a metaverse environment or metaverse world.

For example, online virtual meetings 114 may immerse a user into a virtual bar space where user's avatar performs human actions and interacts with other avatars in the virtual bar space. The online virtual meetings 114 may immerse a user into an office building where a user (using an avatar) enters a conference room space and initiates an online collaboration session with other coworkers (represented by avatars). The 3D games 112 may immerse a user into a fantasy world where user's avatar may look like a unicorn, fly like a bird, swim like a fish, barks like a dog, etc. Metaverse applications 110 may provide training environments such as a surgery room space where the user (using his avatar) performs a surgery on a patient represented by another avatar (e.g., a software-based entity). Further, metaverse applications 110 may render a virtual environment in which a user controls specialized equipment e.g., a machine or a robot, to perform a specific task.

The users interact in the virtual environments provided by the metaverse applications 110 using the human-machine interface 120. The human-machine interface 120 may also vary widely depending at least on use case scenarios. The human-machine interface 120 includes various user devices (endpoint devices) and/or external sensors 128. User devices allow users to interact with the virtual environments and render the virtual environments for the users as instructed by the metaverse applications 110 that define input/output for their respective virtual environment(s). The external sensors generate a plurality of data steams indicative of an environment-based conditions of the physical space, context-based conditions of the physical space, and/or user-based conditions indicative of user's physical attributes, clothing, equipment, biometrics, etc. The human-machine interface 120 is configured to monitor activity in a metaverse environment and may further include specialized user devices such as surgical instruments and/or training equipment with various built-in sensors to detect user interactions/motion.

Typically, however, the human-machine interface 120 includes user devices such as a sensory immersive headset 122, a haptic body suit 124, haptic gloves 126, directional motion simulations, handheld controllers, a keyboard, a touch screen, goggles, a personal computer, and/or etc. These user devices include sensors to detect user's motion, interactions, attributes, and/or biometrics (e.g., pulse, heartrate, etc.). These sensors may further monitor physical space around the user to detect presence of other objects or entities, security state of the space, size, etc. These sensors generate data streams indicative of the real-world environment of the user. The user devices also include one or more visual displays to immerse the user into the metaverse environment. Additionally, the human-machine interface 120 may include user devices such as a microphone, speakers, haptic devices, olfactory devices, etc.

The external sensors 128 such as a camera, may also monitor the user and/or the physical space around the user. The external sensors 128 may generate data streams indicative of the real-world environment of the user.

Specifically, the external sensors 128 may monitor the environment-based characteristics of the physical space that surrounds the user such as but not limited to: the size of the physical space (e.g., the room), presence of other entities in the physical space, presence of one or more objects in the physical space, security state of the physical space (e.g., door locked, window closed, etc.), temperature in the physical space, etc. The external sensors 128 may further monitor context-based characteristics of the physical space such as whether the user is in a hospital, in a bank, in an enterprise branch office, etc. The external sensors 128 may further monitor user-based attributes such as user's clothing, equipment/tools in the vicinity of the user, physical attributes of the user, qualifications of the user, physical capabilities of the user, etc.

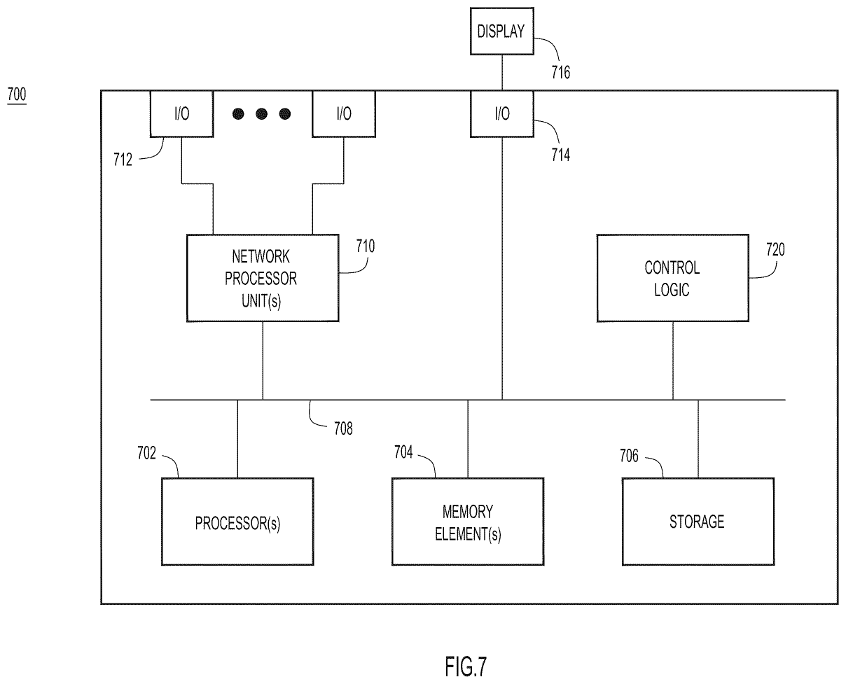

In various example embodiments, user devices and external sensors 128 may each include a network interface, at least one processor, and a memory. Each user device or each external sensor may be an apparatus or any programmable electronic or computing device capable of executing computer readable program instructions. The network interface may include one or more network interface cards (having one or more ports) that enable components of the entity to send and receive packets or data over network(s) such as a local area network (LAN) or a wide area network (WAN), and/or wireless access networks. Each user device or each external sensor may include internal and external hardware components such as those depicted and described in further detail in FIG. 7. In one example, at least some of these user devices and external sensors 128 may be embodied as virtual devices with functionality distributed over a number of hardware devices, such as servers, etc. For example, some of the computational workload may be performed in a cloud.

As noted above, metaverse applications 110 immerse users into virtual environments 130 that vary widely. For example, a virtual environment may be a virtual city space 132 that mimics a real-world city with buildings, streets, shops, etc. As another example, a virtual environment may be an office with conference or meeting rooms in which a table, chairs, a phone, a whiteboard, etc. are provided for the users to interact using their avatars. In yet another example, a virtual environment may be an attorney's office, a bank branch, a surgery room, an exercise gym, a swimming pool, etc. Virtual environments 130 are visually rendered environments that have various characteristics or attributes. Attributes of the virtual environments 130 may be defined based on physics engine, geospatial positions and interaction, art direction, audio design, haptic design, textures, etc. The virtual environments 130 may depict therein virtual entities 140 such as the avatar 142. The avatar 142 represents a human user or a software-based entity (e.g., a patient simulator). The avatar 142 may also include various attributes such as skins, accessories (tools, equipment, etc.), and capabilities (fly, run, etc.). While only the avatar 142 is shown, it is understood that users may have a plurality of avatars. The virtual environments 130 are specified in the metaverse applications 110 and virtual entities 140 may be rendered using the metaverse middleware 150.

In the metaverse system 100, the metaverse middleware 150 provides basic functions 152a-n, a policing agent 154, and policies with real-world conditions 156. The basic functions 152a-n and the policing agent 154 may be loaded onto an operating system (OS) for execution. The notations 1, 2, 3, . . . n; a, b, c, . . . n; “a-n”, and the like illustrate that the number of elements can vary depending on a particular implementation and is not limited to the number of elements being depicted or described. Moreover, the basic functions 152a-n may vary in number and types based on a particular deployment and use case scenario.

The basic functions 152a-n include processing engines, analytics, trackers, and/or detectors, for rendering and interacting in the virtual environments 130. The processing engines include a three-dimensional (3D) engine for rendering virtual environments 130 in 3D (360 degrees view), physics engines that define interactions in the virtual environments 130, and audio engines that process detected audio stream and/or render sounds and/or utterances in the virtual environments 130. Trackers track the state of a virtual environment (running, loaded, etc.), state and location of avatars (e.g., at a particular location within the virtual environment), etc. The tracking information may be shared in the metaverse environment. Detectors detect collisions among avatars or objects, conflicts in rendering various objects, etc. The metaverse middleware 150 may further include financial services, advertising services, e-stores (for avatars, skins, accessories, etc.), design tools, and frameworks. In one example embodiment, the metaverse middleware 150 includes a standard library of basic functions (not specific to metaverse) and the metaverse-related functions are defined by respective metaverse applications.

According to one or more example embodiments, the metaverse middleware 150 further includes the policing agent 154 and the policies with real-world conditions 156, which are configured to ensure that minimal real-world conditions are satisfied for immersing the user into a virtual environment rendered by a respective metaverse application. Entities such as metaverse application developers, owners, providers, etc., define real-world requirements using policies with real-world conditions 156. The policing agent 154 enforces these policies to ensure that the metaverse applications are being used in an approved mode e.g., safely and/or securely. Specifically, the policing agent 154 receives signals or indicators from the human-machine interface 120 (user devices and/or external sensors 128) and determines whether real-world environment of a user satisfies one or more of the applicable policies for a respective metaverse application.

In the metaverse system 100, the metaverse infrastructure 160 may include various hardware and software components 162a-m. Specifically, the metaverse infrastructure 160 includes appropriate hardware (e.g., processor(s), memory element(s), antennas and/or antenna arrays, baseband processors (modems), and/or the like such as those depicted and described in further detail in FIG. 7), software, logic, and/or the like to facilitate rendering metaverse environment and executing metaverse applications 110. For example, the metaverse infrastructure 160 includes compute resources (memories, CPUs, etc.), network and telecommunications (network interfaces, antennas, etc.), bandwidth, processing capacity, hosting, geolocation tracking/blocking (sensors), access and security related components (firewall, etc.), graphics processing units (GPUs), etc.

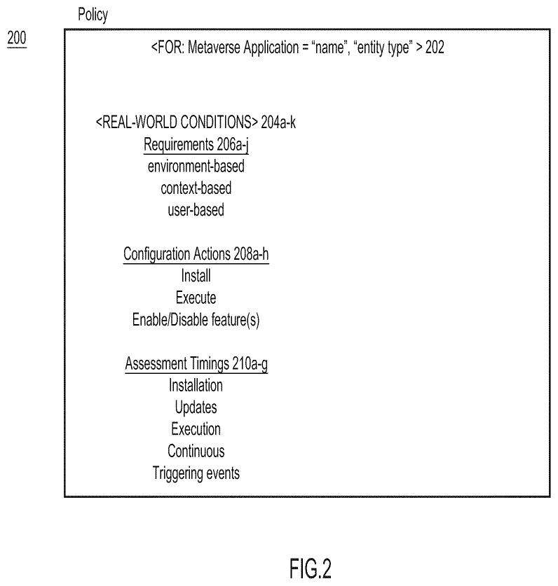

With continued reference to FIG. 1, FIG. 2 is a view illustrating a policy 200 that defines real-world conditions associated with a metaverse application, according to an example embodiment. The policy 200 includes an identification 202 of a metaverse application and a plurality of real-world conditions 204a-k for the metaverse application.

The policy 200 is defined in a machine-readable format and may be in a form of one or more schemas e.g., Extensible Markup Language (XML) schemas and/or JavaScript Object Notation (JSON) schemas. The schemas involve a definition of entity types, enumerations, validations, properties, attributes, etc. which are sufficient to express the requirement in a manner which can be read by and actioned by software agents such as the policing agent 154 of FIG. 1. An example of an expression of feature usage requirements in a Digital Rights Management (DRM) may involve a content owner expressing usage requirements for how their content can be experienced within media players such as “advertisements cannot be skipped”, “can only be watched once”, etc. The policy 200 is generated in a standardized descriptor format for expressions of feature restricting requirements or policy clauses.

The identification 202 in the policy 200 indicates one or more metaverse applications to which the policy applies. The identification 202 may include a name of a metaverse application, a unique identifier of the metaverse application, a storage location of the metaverse application, a pointer or link to the location of the metaverse application, etc. While in the policy 200, the identification 202 identifies only one metaverse application “name,” this is just an example. The identification 202 may include multiple identifiers for a plurality of metaverse applications.

In one example embodiment, the identification 202 may identify a particular category or type of metaverse applications e.g., metaverse exercise applications, metaverse applications developed by an enterprise A, etc. In one example embodiment, an entity type identifies an object or an element that is being described or modeled in the schema. For example, a schema that defines the policy 200 includes one or more entities (or entity types) that represent a metaverse application, a set of real-world conditions, etc. Entity types are generally the nouns within the domain of consideration. In a manufacturing setting, entity types may include robots, belts, tool, shifts, etc. Categories may further be defined based on a type of the human-machine interface 120, context or purpose of the metaverse applications 110, metaverse application owner, etc. In one example embodiment, the identification 202 may further identify an entity and/or entity type that generated the real-world conditions 204a-k.

The real-world conditions 204a-k in the policy 200 define requirements/restrictions that relate to the actual, physical environment of the user. The real-world conditions 204a-k include one or more attributes of the user in the physical world and/or one or more characteristics of the physical space that surrounds the user in the real-world environment. Real-world conditions 204a-k include requirements 206a-j, configuration actions 208a-h, and assessment timings 210a-g. The real-world conditions 204a-k are policy clauses that specify restrictions in the real-world and configuration actions to take when these restrictions are satisfied or partially satisfied. Configuration actions are in the metaverse environment and relate to the metaverse application. The policy clauses further specify timing for checking the physical environment of the user.

The real-world conditions 204a-k may be granularly defined by various entities. In one example embodiment, the real-world conditions 204a-k are defined by one entity (e.g., metaverse application owner or provider). In yet another example embodiment, the real-world conditions 204a-k is an aggregation of various real-world restrictions specified by a plurality of entities. The real-world conditions 204a-k are defined by an enterprise that uses the metaverse application, a service/application provider, an application developer, one or more regulatory entities, and/or a digital service regulator(s).

For example, a developer of a metaverse dancing application may define a minimum physical space (e.g., at least 6 feet of empty physical space surrounding the user) required for safely interacting in the virtual environment rendered by the metaverse dancing application. The metaverse application developer may set the assessment timing as before running or executing the metaverse dancing application. In other words, the developer defines real-world requirement to safely “dance” in the virtual dancing environment.

As another example, a metaverse hosting enterprise and/or user's enterprise may define the real-world conditions 204a-k to include characteristics of the physical space that surrounds the user. Specifically, if the door to the room is unlocked, do not install metaverse banking application.

As noted above, regulatory entities may impose their own requirements on the metaverse applications (e.g., the metaverse applications 110 of FIG. 1). Regulatory entities include health and safety organizations, employee rights organizations, and/or digital service regulators. A regulatory entity of a metaverse training application may define one or more physical attributes of the user, qualification-based attributes of the user, clothing to be worn by the user, and/or equipment that is to be present in the vicinity of the user. Specifically, the regulatory agency may define the real-world conditions 204a-k such as: (a) if the user is shorter than 5 feet and/or is not a medical student, do not run the metaverse training application, (b) if the user is not wearing a white coat and gloves, do not initiate a medical training procedure in the virtual operating room environment, and (c) if medical tools are located further than one foot from the user, do not enable a first feature of the metaverse training application e.g., administering anesthesia to a patient avatar, etc.

Since the real-world conditions 204a-k may be defined by many entities e.g., with respect to the installation, execution and/or use of the metaverse application (and/or its feature(s)), conflicts may arise. The policing agent 154 resolves conflicts using hierarchy, scoring factors, weighing, etc. and/or aggregates various defined requirements to generate a master policy or a manifest.

In one example embodiment, the policing agent 154 obtains a plurality of policies which define real-world conditions 204a-k for an associated metaverse application. Each policy is generated by a different entity. The policing agent 154 applies hierarchy and factoring rules to aggregate the real-world conditions 204a-k into an aggregated policy. Some real-world conditions 204a-k may be removed or modified in the aggregated policy.

For example, the digital service regulator's demands may have the highest priority and cannot be rescinded because a violation of these demands may be a crime. As another example, a signature feature for signing a document in a virtual office environment rendered by a metaverse application, is available/enabled by an application owner but user's enterprise may add an additional real-world requirement that requires the presence of a witness (another person in the virtual office environment) before rendering the signature feature.

The policing agent 154 may apply different rules and/or strategies depending on a particular use-case scenario. Requirement setting entities may be placed within a hierarchy and/or maybe given weighting or scoring factors. The policing agent 154 determine priorities and resolve conflicts within a set of feature restricting requirements (real-world conditions 204a-k). The policing agent 154 manages a pool of demands (the real-world conditions 204a-k) by prioritizing between them and by resolving conflicts within them.

According to one or more example embodiments, the real-world conditions 204a-k may further define fallback actions and/or degrees of operation. The metaverse environment may be configured with degrees of operation based on the real-world conditions 204a-k being only partially satisfied.

For example, a first real-world condition may specify that user's pulse needs to be below 99 beats per minute and a second real-world condition may specify a requirement of six feet empty physical space around the user. Based on the policing agent 154 determining that user's pulse is 80 beats per minute and the empty physical space surrounding the user is only three feet instead of the required six feet, only stretching exercises may be rendered by the metaverse dancing application and no dancing moves are providing (e.g., dancing moves feature is disabled).

As another example, when the policing agent 154 determines that another avatar is present in the virtual bank office (when no other entities are allowed by the policy), the metaverse banking application may enable general/default features that provide public information and restrict features that would provide confidential information.

The real-world conditions 204a-k include a degree of operation/configuration when the real-world requirements are only partially satisfied. In one example embodiment, a configuration action may be more than a binary enable/disable, install/do not install, etc. The configuration action may define granular configurations of the metaverse environment with gradual metaverse feature degradation as the real-world requirements are not fully satisfied. The more of the requirements 206a-j are satisfied, the more features of the metaverse application are enabled. Also, configuring the metaverse environment by the metaverse application depends on the type and number of real-world requirements that are satisfied, e.g., one or more features of the metaverse application are selected and enabled.

According to one example embodiment, the real-world conditions 204a-k may further define fallback positions that should be actioned if the requirements cannot be assessed e.g., due to a lack of access to appropriate sensors and/or services. For example, if the user's pulse rate is not available, the metaverse dancing application may be restricted to breathing exercises only.

The real-world conditions 204a-k may further define one or more communications with the user. The real-world conditions 204a-k may define whether the user is to be notified as the requirements are being assessed, met, failed, etc. The policing agent 154 determines whether to inform the user as defined in the real-world conditions. In some cases, it is desirable to provide information about what is occurring to the user (e.g., no white coat, cannot initiate the surgery or cannot detect pulse rate, only breathing exercises are provided). However, there may be times when the user should not be informed that there are features of an application to which access is denied/disabled. For example, since another user is present in the physical space, review of a new confidential document is disabled. The determination of whether to notify the user may also be a part of the requirements setting process.

The sum of the real-world conditions 204a-k of the specifiers (various entities) are aggregated in a form of an aggregated policy that is accessible by the policing agent 154. The policing agent 154 actions these real-world conditions 204a-k and configures the metaverse environment accordingly. For example, a master record (e.g., the policy 200) may be located alongside the metaverse application installation infrastructure being used. An enterprise entity may hold a governing manifest for how the metaverse applications used by the enterprise users can be interacted with.

In one example embodiment, the policy 200 may be expressed at an application level in a form of a manifest that sits alongside the binary installation. A policy statement for a metaverse application may be part of an installation set. In one example embodiment, the manifest may be co-located with the metaverse application executable code in a (local or remote) storage such as in a device filesystem. The binary installation may be an installation package such that when a metaverse application is being installed, any number of assets are obtained from an application store to complete a local installation. These assets may include binary assets (such as an executable file itself), but may also include other assets such as manifests, images, license files, configuration files, etc.

In another example embodiment, the operating systems may apply permissioning models in which the policy is obtained and applied. In yet another example embodiment, the policy 200 may be accessed on demand by the operating system as the user interacts with one or more features of the metaverse application. The techniques presented herein provide that the set of feature restricting requirements (the policy 200) is stored in a location that is readily accessible by the software agent such as the policing agent 154, which is tasked with actioning these feature restricting requirements (e.g., the requirements 206a-j).

The requirements 206a-j are restrictions in the physical world for a virtual environment rendered by the specific metaverse application to be in an acceptable mode for entities involved. The requirements 206a-j are real-world demands imposed on a user interacting within the metaverse environment. The requirements 206a-j define characteristics of the user's physical space and/or user's attributes in the real world.

The requirements 206a-j may fall into various classes or categories such as the geographical location of the user, the user's real-world environmental surroundings, the physical capabilities of the user, the qualifications of the user, the clothing and/or equipment being worn by the user, the date or time of use, the physical security of the user and/or any application equipment they may be using, the co-location between multiple application users, the co-location between the user and people sharing the physical space but not taking part within the virtual environment, etc. Many categories may be defined in the requirements 206a-j. In one example embodiment, the category and specifics of the requirement become more detailed overtime.

The requirements 206a-j may involve environment-based conditions for the physical space such as the size of the physical space, presence of one or more other users or objects in the physical space that are part or not part of the virtual environment rendered by the metaverse application, the security state of the physical space (e.g., door closed, window locked, etc.), temperature in the physical space, etc. The requirements 206a-j may further involve context-based conditions for the physical space. For example, the user may execute the metaverse medical training application only if the user is in an operating room in a hospital.

The requirements 206a-j may involve user-based conditions that specify one or more attributes of the user. The user-based conditions include physical attributes of the user (height, weight, eye color, hair length, etc.) and/or qualification-based attributes of the user (e.g., an identification batch, certificates, licenses, earned degrees, etc.) The user-based conditions may further include a co-location of the user and at least one other user of the metaverse application. For example, pilot and copilot need to be in the same room for virtually operating a plane in a virtual environment rendered by a metaverse flight training simulation application. The user-based conditions may further include physical capabilities of the user (e.g., can jump, walk, talk, etc.), user clothing (e.g., gloves and white coat), equipment or tools within user's reach, etc.

The above are just some examples of the requirements 206a-j. The requirements 206a-j may include many other characteristics and/or attributes of the real-world environment (e.g., sunny outside), co-location of other users in the virtual environment (e.g., all users are physically present in the United States), etc. In other words, the number and type of requirements 206a-j varies widely based on use case scenarios and entities involved.

The real-world conditions 204a-k further define configuration actions 208a-h that are to be performed based on at least partially satisfying the requirements 206a-j. The configuration actions 208a-h involve installing a metaverse application or a portion thereof, executing the metaverse application in various modes, updating the metaverse application, and/or enabling or disabling one or more features of the metaverse application. For example, based on only partially satisfying the requirements 206a-j, the metaverse application is executed in a default mode such that the user may enter a bank building in the virtual financial environment but cannot enter any of the conference rooms in the bank (e.g., doors are shown as locked). When other entities in the physical space of the user are no longer detected, the conference room doors are unlocked and the user has access (i.e., the metaverse application is executed in a normal mode). When the user enters the conference room, the user may then invite other entities (e.g., clients) to enter the virtual conference room (i.e., the metaverse application enables additional features).

The policing agent 154 of FIG. 1 determines whether the real-world environment of the user satisfies one or more of the requirements 206a-j and configures the metaverse environment based on the satisfied requirements. Configuring the metaverse environment may include certifying and/or adopting the metaverse environment based on the real-world conditions. The policing agent 154 has access to the full set of requirements (real-world conditions 204a-k) associated with a metaverse application after priorities and conflicts have been resolved. These real-world conditions 204a-k are in a format which is readily readable and interpretable by the policing agent 154. The policing agent 154 is configured to obtain information about the real-world environment of the user and determining whether they satisfy the requirements 206a-j defined in the policy 200.

In one example embodiment, individual policy clauses are broken down into two sets: those that can be policed without involving external sensors or services and those which require the presence of external sensors or services such as the external sensors 128 in FIG. 1. Some examples of the policy clauses that can be policed without involving external sensors or services include: time based clauses—e.g., not after . . . ; network based clauses—e.g., not unless IP address is . . . ; geography based clauses—e.g., only if within country . . . ; user based clauses—e.g., only if user is . . . ; equipment based clauses—e.g., only if headset version is . . . ; etc. Some examples of policy clauses that require external sensors such as the external sensors 128 in FIG. 1 include: environmental based clauses—e.g., only in a locked room—requires access to building management systems; physical capability-based clauses—e.g., only if user's height is . . .—requires access to user information systems; qualification-based clauses—e.g., only if user has training for . . .—requires access to user information systems; context-based clauses—e.g., only if within a hospital—requires access to context aware services; etc.

An early step in determining compliance with the policy 200 includes the policing agent 154 determining whether sufficient access to sensors and services (e.g., user devices and external sensors 128 in FIG. 1) is available to execute on the defined policy statement. If the policing agent 154 is unable to police some aspects of the policy 200, then fallback positions are used to decide what remedial action needs to be taken. As noted above, these fallback positions may also be defined in the policy 200.

Different policy clauses may be assessed at different times in the metaverse application lifetime. Assessment timings 210a-q specify the time for assessing the real-world conditions 204a-k i.e., whether the requirements 206a-j are satisfied. The policing agent 154 analyzes whether the user's real-world environment meets the requirements 206a-j based on the assessment timings 210a-q. The assessment timings 210a-q may include checking the user's real-world environment at an installation of the metaverse application, prior to updating the metaverse application, prior to executing the metaverse application, based on particular triggering event(s), and/or continuously during use of the metaverse application.

For example, an assessment timing may specify that the policy 200 (or one or more of the real-world conditions 204a-k) is to be applied at the installation of the metaverse application, at a startup of the metaverse application, or as one or more features of the metaverse application are being requested/used. Policy clauses that fail at the installation time are indicative of a metaverse application that cannot be installed on the target device or installed for access by the target user. Policy clauses that fail at the start-up time of the metaverse application are indicative of a metaverse application that was installed but is not operative for the target user. Policy clauses that are being assessed as the metaverse application is being used, enable or disable features within the metaverse application based on dynamic assessments of these policy clauses e.g., when the real-world environment no longer satisfies the conditions enumerated in the policy 200.

Policy clauses that are being assessed based on a triggering event (e.g., user enters a conference room in a virtual meeting environment) are indicative of enabling or disabling one or more features of the metaverse application while the metaverse application is executing (e.g., enable access to documents on a white board, disable access to confidential documents in a filing cabinet in the virtual meeting environment). Some triggering events may cause reconfiguration of the metaverse environment and the termination of the virtual environment rendered by the metaverse application.

With continued reference to FIGS. 1 and 2, FIGS. 3-5 are sequence diagrams illustrating methods of configuring the metaverse environment based on the real-world environment of the user and the real-world conditions defined in one or more policies. The methods involve a user device 312 that may be worn by a user 310, additional sensors 314 that maybe inside or outside a physical space 320 that surrounds the user 310, a policing agent 330 such as the policing agent 154 of FIG. 1 that obtains a policy 332 such as the policy 200 of FIG. 2. The policy 332 is one or more machine-readable schemas.

The user device 312 and the additional sensors 314 are configured to monitor real-world environment including attributes of the user 310 and characteristics of the physical space 320. The user device 312 is a suitably enabled user device e.g., head-mounted display, hand-held controllers, the sensory immersive headset 122 of FIG. 1, etc.

The user device 312 may detect biometric signals and behavioral characteristics of the user 310 in the physical space 320. The user device 312 may incorporate biometric monitors or sensors that monitor biometrics and vital signs. In one example embodiment, the biometric sensors include one or more of: skin temperature sensors, retinal scanners, photoplethysmography (using green LEDs and pairing them with photodiodes to detect blood flowing through the skin), fingerprint readers, and/or gait measurements.

These are just some non-limiting examples of the biometric sensors incorporated into the user device 312. While, in one example embodiment, these biometric sensors are embedded into one or more user devices such as a headset or hand-held controller(s), in another example embodiment, at least some of these biometric sensors may be independent of the user devices and be part of the additional sensors 314 (e.g., a heart monitor or another standalone sensor). As human-computer interaction (HCI) devices (such as devices and/or sensors of the human-machine interface 120 of FIG. 1) evolve, additional sensors may be added and/or existing sensor arrays may further be refined to help enable new metaverse applications and experiences for users and/or developers, and as such, are within the scope of this disclosure.

The user device 312 and additional sensors 314 are further configured to detect behavioral characteristics of the user 310 that is interacting within the metaverse environment. In this case, the user device 312 and additional sensors 314 include motion sensors such as one or more accelerometers and gyroscopes. In one example embodiment, these motion sensors are integrated into the user device 312. The motion sensors record behavioral characteristics as device inputs such as user motion data (via a device multi-axis inertial measurement unit (IMU)). The sensors may also include one or more microphones that detects audio stream such as user speech and utterances. The microphones may be a separate device or integrated into one or more of the user devices such as the sensory immersive headset 122 of FIG. 1.

The additional sensors 314 may include one or more cameras that monitor the physical space 320 of the user 310. The additional sensors 314 may include sensors of various systems such as a building management system, user information systems, and/or context aware services.

The policing agent 330 is configured to enforce real-world conditions such as enumerations of the real-world conditions 204a-k of FIG. 2, defined in the policy 332 such as the policy 200 of FIG. 2. The policy 332 includes enumerations of one or more policy clauses that have at least one requirement (e.g., the requirements 206a-j of FIG. 2), configuration for the metaverse environment (e.g., the configuration actions 208a-h of FIG. 2), and at least one assessment timing (e.g., the assessment timings 210a-g of FIG. 2).

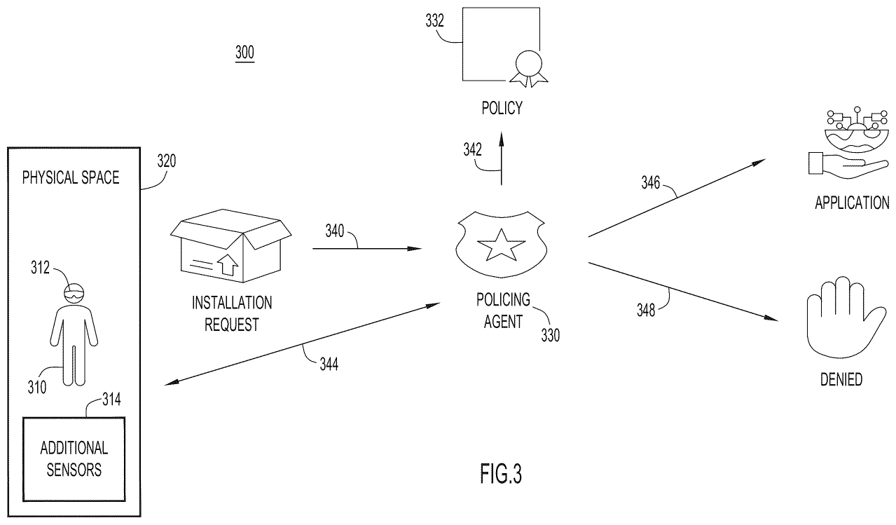

FIG. 3 is a sequence diagram illustrating a method 300 of determining whether real-world environment satisfies a policy for installing a metaverse application, according to an example embodiment.

The method 300 involves the user 310 interacting within the metaverse environment. At 340, an installation request is intercepted by the policing agent 330. The installation request may be based on the user 310 requesting the installation of a metaverse application in a trusted user interface (UI) of the metaverse environment. The trusted UI provides a metaverse environment in which one or more metaverse applications may be selected for installation and/or execution. The installation request may be generated by the metaverse environment e.g., the metaverse middleware 150 of FIG. 1, based on a triggering event.

At 342, the policing agent 330 accesses the policy 332 that includes one or more policy statements or policy clauses. For example, based on the name of the metaverse application in the installation request, the policing agent 330 obtains the policy 332 associated with (or related to) the metaverse application. Policy 332 that relates to a metaverse application may include, but is not limited to, real-world conditions imposed by the metaverse application developer, by the user's enterprise, and/or a regulatory entity. The policy 332 includes one or more policy clauses or statements that govern the installation request. The policing agent 330 analyzes the policy 332 to determine real-world conditions to assess.

At 344, the policing agent 330 obtains information about the real-world environment including attributes of the user 310 and/or characteristics of the physical space 320. The policing agent 330 then determines whether the policy clauses related to the installation of the metaverse application are satisfied. Specifically, the policing agent 330 determines whether all or some of the requirements in the policy 332 are either met or are assessable through the availability of third-party senses and services.

If all requirement clauses are satisfied, at 346, the metaverse application installation is authorized and the metaverse environment is configured to install the metaverse application that renders one or more virtual environments. In one example, if some of the requirement clauses are satisfied, only a default or basic version of the metaverse application installation is authorized and the metaverse environment is configured to install the default version of the metaverse application that may render only one virtual environment e.g., public lobby of the office building without access to conference rooms.

When requirement clauses in the policy 332 are not satisfied and/or cannot be assessed, a fallback position is implemented. The fallback position may also be specified in the policy 332 and/or provided in the setting for the metaverse environment. When the fallback position in the policy 332 dictates, at 348, the metaverse application installation is denied.

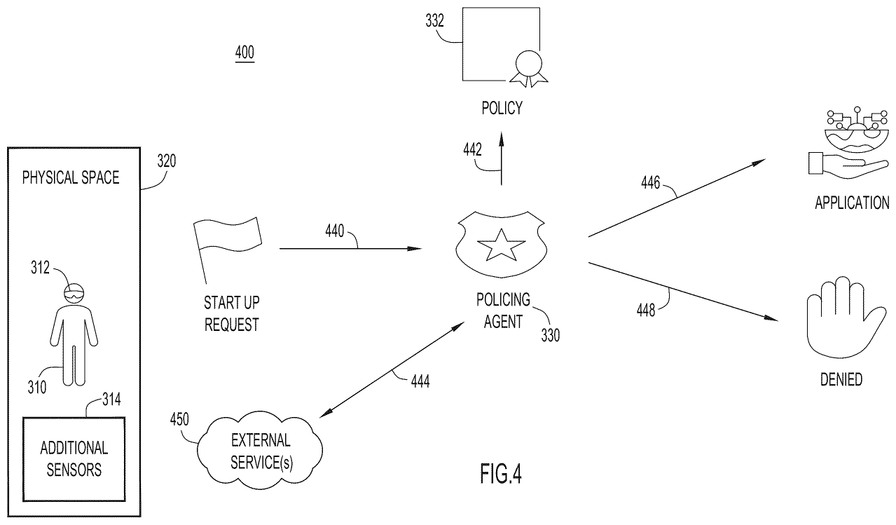

FIG. 4 is a sequence diagram illustrating a method 400 of determining whether real-world environment satisfies a policy for executing a metaverse application, according to an example embodiment. The method 400 relates to determinations with respect to an already installed metaverse application. The method 400 further involves external service(s) 450. The external service(s) may involve a building management system, user information systems, and/or context aware services. The method 400 involves the user 310 interacting within the metaverse environment. At 440, a startup request is intercepted by the policing agent 330. The startup request may be based on the user 310 requesting to run or execute a metaverse application in a trusted UI of the metaverse environment.

At 442, the policing agent 330 accesses the policy 332 that includes one or more policy statements or policy clauses. The policy 332 includes real-world conditions required for running the metaverse application i.e., for rendering one or more virtual environments. The policing agent 330 analyzes the policy 332 to determine real-world conditions to assess and collects information about the real-world environment of the user 310.

At 444, the policing agent 330 may communicate with one or more external service(s) 450 to determine whether context-based conditions are satisfied. For example, the policing agent 330 may communicate with the building management system to determine temperature in the room, with a user information system to determine user's qualifications (e.g., licenses, etc.), and/or context aware services to determine if the user is in a hospital setting, enterprise's branch office or main office, etc. The policing agent 330 uses third-party senses or services to assess whether policy clauses are satisfied.

If all requirement clauses are satisfied, at 446, the metaverse application execution is authorized and the metaverse environment is configured to start up the metaverse application that renders one or more virtual environments i.e., immerses the user 310 into the virtual environment rendered by the metaverse application e.g., the user is immersed into a virtual conference room.

When requirement clauses in the policy 332 are not satisfied and/or cannot be assessed, a fallback position is implemented. When the fallback position in the policy 332 dictates, at 448, starting the metaverse application is denied. For example, the user does not have the necessary qualifications to run the metaverse application and as such, the policing agent 330 disables the start of the metaverse application.

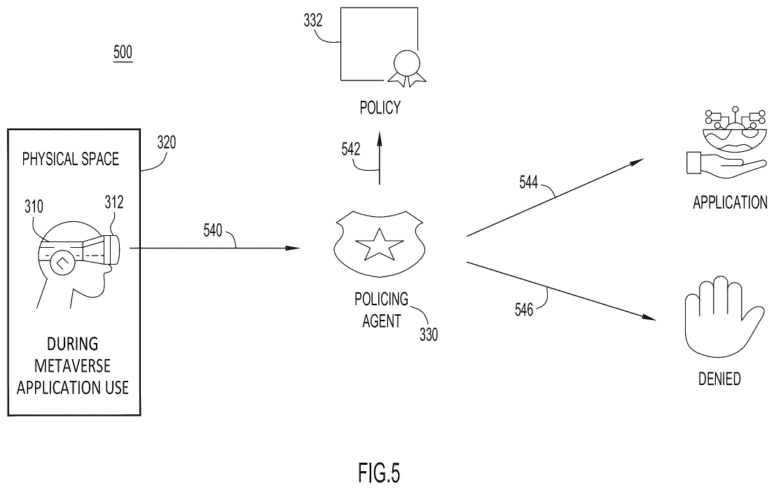

FIG. 5 is a sequence diagram illustrating a method 500 of determining whether real-world environment satisfies a policy for enabling or disabling one or more features in a running instance of a metaverse application, according to an example embodiment. The method 500 dynamically determines whether to allow or deny (enable or disable) one or more features within the running instance of a metaverse application in a metaverse environment.

The method 500 may involve complex interactions and/or determinations. That is, the user 310 is using the metaverse application and is immersed into a virtual environment rendered by the metaverse application. As the user is using the metaverse application, at 540, a constant stream of requests is being sent to the policing agent 330. The plurality of data streams from the plurality of sensors that monitor activity of the user 310 and the real-world environment i.e., the user 310 and/or the physical space 320. These data streams (steam of requests) may be directly initiated by the metaverse application itself and/or the policing agent 330 that may have interposed itself into the running metaverse environment to the metaverse application such that it can action policies without the metaverse application's cooperation.

At 542, the policing agent 330 accesses the policy 332 that includes at least one policy statement. The policing agent 330 then determines whether the policy statement for feature inclusion have been met or no longer is met.

When the policy clauses or policy statements have been satisfied, at 544, the feature is available and enabled. The user 310 may be unaware that any such assessments or determinations are being made during the use of the metaverse application.

When the policy clauses are not satisfied, at 546, the feature will not be made available or will be disabled. This may or may not be communicated to the user 310 depending on the fallback conditions expressed within the policy 332. It is possible for users to interact with a metaverse application and not be aware that some features are denied/disabled. In this scenario, the policing agent 330 is actively involved within the execution space of the metaverse application and is continuously assessing (or being asked) the suitability of the features being presented to the user 310. When the real-world environment of the user no longer satisfies the enumerated conditions of the policy 332, the method 500 involves reconfiguring the metaverse environment by disabling features, for example.

The policing agent 330 may continuously monitor use of the metaverse application to determine an occurrence of a triggering event that may cause the termination of the metaverse application and/or restriction of access to certain features of the metaverse application. That is, some triggering events may cause a reconfiguration of the metaverse environment. For example, the user 310 may be restricted from accessing a virtual conference room rendered by a metaverse meeting application based on detecting the presence of an external user or avatar that is not part of the user's enterprise. That is, when the real-world conditions no longer satisfy the policy 332, the metaverse application may be terminated. The policing agent 330 may use the real-world conditions of the policy 332 to determine whether to perform updates of the metaverse application and/or reconfigure the metaverse environment.

The techniques presented herein provide for defining minimal real-world conditions that are needed before a metaverse application may be installed, executed, and/or before a feature in the metaverse application can be used. The conditions are defined in a form of a policy that is policed by one or more software agents. The techniques presented herein ensure that the metaverse application are executed safely and securely and comply with real-world requirements that may be imposed by various entities such as regulatory organizations, program developers, and/or enterprises of the users.

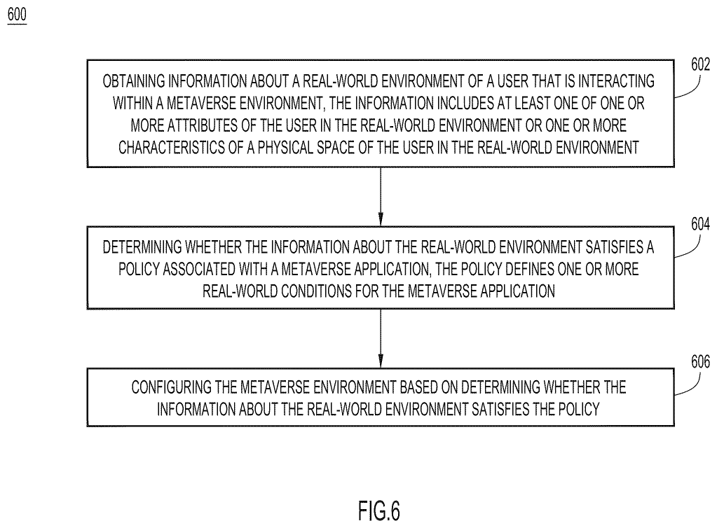

FIG. 6 is a flowchart illustrating a method 600 of configuring the metaverse environment based on determining whether the information about the real-world environment satisfies the policy, according to an example embodiment. The method 600 may be performed by one or more computing devices. For example, the method 600 may be performed by the policing agent 154 of FIG. 1 or the policing agent 330 of FIGS. 3-5.

The method 600 involves at 602, obtaining information about a real-world environment of a user that is interacting within a metaverse environment. The information includes at least one of one or more attributes of the user in the real-world environment or one or more characteristics of a physical space of the user in the real-world environment.

The method 600 further involves at 604, determining whether the information about the real-world environment satisfies a policy associated with a metaverse application. The policy defines one or more real-world conditions for the metaverse application.

The method 600 further involves at 606, configuring the metaverse environment based on determining whether the information about the real-world environment satisfies the policy.

In one instance, the operation 606 of configuring the metaverse environment may include, based on determining that the information about the real-world environment satisfies each of the one or more real-world conditions defined in the policy, performing one or more of: installing the metaverse application to render one or more virtual environments of the metaverse application, executing the metaverse application to immerse the user within the one or more virtual environments rendered by the metaverse application, or enabling or disabling at least one feature of the metaverse application that is configured to render the one or more virtual environments.

According to one or more example embodiments, the information about the real-world environment may be obtained by monitoring the user and the physical space that surrounds the user in the real-world environment while the user is interacting within the metaverse environment. The method 600 may further involve, based on determining that the information about the real-world environment no longer satisfies each of the one or more real-world conditions defined in the policy, reconfiguring the metaverse application by performing one or more of: disabling a first feature of the metaverse application, enabling a second feature of the metaverse application, or terminating or restricting access to one or more virtual environments rendered by the metaverse application.

In one form, the operation 602 of obtaining the information about the real-world environment may include obtaining a plurality of data streams from a plurality of sensors that are configured to monitor activity of the user in the real-world environment and the physical space in which the user is interacting within the metaverse environment.

According to one or more example embodiments, the one or more real-world conditions defined in the policy may include at least one of: an environment-based condition for the physical space including one or more of: size of the physical space, presence of one or more other users or objects in the physical space, security state of the physical space, or temperature in the physical space, a context-based condition for the physical space, or a user-based condition including one or more of: a physical attribute of the user, a qualification-based attribute of the user, or a co-location of the user and at least one other user of the metaverse application. The physical attribute may include at least one of a physical capability of the user, a physical feature of the user, clothing worn by the user, or an equipment in the physical space.

In one instance, the operation 604 of determining whether the information about the real-world environment satisfies the policy may include determining whether the physical space of the user in the real-world environment satisfies each condition related to the physical space defined in the policy based on the plurality of data streams, and determining whether the one or more attributes of the user in the real-world environment satisfy each of the user-based condition defined in the policy based on the plurality of data streams.

In another instance, the one or more real-world conditions defined in the policy may include at least one real-world requirement for immersing the user into one or more virtual environments rendered by the metaverse application.

In yet another instance, the one or more real-world conditions defined in the policy may include at least one first condition defined by a provider of the metaverse application, at least one second condition defined by an enterprise of the user, and at least one third condition defined by a regulatory entity associated with the metaverse application.

According to one or more example embodiments, the one or more real-world conditions may be defined in a machine-readable schema that includes one or more real-world requirement enumerations, one or more associated configuration actions, and one or more assessment timings, for installing, executing, or enabling features in the metaverse application.

In one form, the operation 604 of determining whether the information about the real-world environment satisfies the policy may include determining that the information about the real-world environment does not satisfy at least one real-world condition defined in the policy and selecting one or more features of the metaverse application to enable based on a number and type of the one or more real-world conditions that are satisfied.

FIG. 7 is a hardware block diagram of a computing device 700 that may perform functions associated with any combination of operations in connection with the techniques depicted in FIGS. 1-6, according to various example embodiments, including, but not limited to, operations of one or more user devices such as at least some of the user devices of the human-machine interface 120 of FIG. 1, the policing agent 154 of FIG. 1, or the policing agent 330 of FIGS. 3-5. It should be appreciated that FIG. 7 provides only an illustration of one example embodiment and does not imply any limitations with regard to the environments in which different example embodiments may be implemented. Many modifications to the depicted environment may be made.

In at least one embodiment, computing device 700 may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and control logic 720. In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with one or more memory elements 704 (or vice versa), or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, and/or any other I/O port(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714 allow for input and output of data and/or information with other entities that may be connected to computing device 700. For example, I/O interface(s) 714 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor 716, a display screen (touch screen on a mobile device), or the like.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, an apparatus is provided. The apparatus includes a communication interface to enable communication with devices operating to provide a metaverse environment and a processor. The processor is configured to perform various operations including obtaining information about a real-world environment of a user that is interacting within a metaverse environment. The information includes at least one of one or more attributes of the user in the real-world environment or one or more characteristics of a physical space of the user in the real-world environment. The operations further include determining whether the information about the real-world environment satisfies a policy associated with a metaverse application. The policy defines one or more real-world conditions for the metaverse application. The operations further include configuring the metaverse environment based on determining whether the information about the real-world environment satisfies the policy.

In yet another example embodiment, one or more non-transitory computer readable storage media encoded with instructions are provided. When the media is executed by a processor, the instructions cause the processor to execute a method that involves obtaining information about a real-world environment of a user that is interacting within a metaverse environment. The information includes at least one of one or more attributes of the user in the real-world environment or one or more characteristics of a physical space of the user in the real-world environment. The method further involves determining whether the information about the real-world environment satisfies a policy associated with a metaverse application. The policy defines one or more real-world conditions for the metaverse application. The method further involves configuring the metaverse environment based on determining whether the information about the real-world environment satisfies the policy.

In yet another example embodiment, a system is provided that includes the devices and operations explained above with reference to FIGS. 1-7.

The programs described herein (e.g., control logic 720) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 706 and/or memory elements(s) 704 can store data, software, code, instructions (e.g., processor instructions), logic, parameters, combinations thereof, and/or the like used for operations described herein. This includes the storage 706 and/or memory elements(s) 704 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein, the terms may be used in a generic sense to include packets, frames, segments, datagrams, and/or any other generic units that may be used to transmit communications in a network environment. Generally, the terms reference to a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data, or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining information about a real-world environment of a user that is interacting within a metaverse environment, wherein the information includes at least one of one or more attributes of the user in the real-world environment or one or more characteristics of a physical space of the user in the real-world environment;
determining whether the information about the real-world environment satisfies a policy associated with a metaverse application, wherein the policy defines one or more real-world conditions for the metaverse application; and
configuring the metaverse environment based on determining whether the information about the real-world environment satisfies the policy.

2. The method of claim 1, wherein configuring the metaverse environment includes:
based on determining that the information about the real-world environment satisfies each of the one or more real-world conditions defined in the policy, performing one or more of:
installing the metaverse application to render one or more virtual environments of the metaverse application;
executing the metaverse application to immerse the user within the one or more virtual environments rendered by the metaverse application; or
enabling or disabling at least one feature of the metaverse application that is configured to render the one or more virtual environments.

3. The method of claim 1, wherein the information about the real-world environment is obtained by monitoring the user and the physical space that surrounds the user in the real-world environment while the user is interacting within the metaverse environment, and further comprising:
based on determining that the information about the real-world environment no longer satisfies each of the one or more real-world conditions defined in the policy, reconfiguring the metaverse application by performing one or more of:
disabling a first feature of the metaverse application,
enabling a second feature of the metaverse application, or
terminating or restricting access to one or more virtual environments rendered by the metaverse application.

4. The method of claim 1, wherein obtaining the information about the real-world environment includes:
obtaining a plurality of data streams from a plurality of sensors that are configured to monitor activity of the user in the real-world environment and the physical space in which the user is interacting within the metaverse environment.

5. The method of claim 4, wherein the one or more real-world conditions defined in the policy include at least one of:
an environment-based condition for the physical space including one or more of: size of the physical space, presence of one or more other users or objects in the physical space, security state of the physical space, or temperature in the physical space,
a context-based condition for the physical space, or
a user-based condition including one or more of: a physical attribute of the user, a qualification-based attribute of the user, or a co-location of the user and at least one other user of the metaverse application, wherein the physical attribute includes at least one of a physical capability of the user, a physical feature of the user, clothing worn by the user, or an equipment in the physical space.

6. The method of claim 5, wherein determining whether the information about the real-world environment satisfies the policy includes:
determining whether the physical space of the user in the real-world environment satisfies each condition related to the physical space defined in the policy based on the plurality of data streams; and
determining whether the one or more attributes of the user in the real-world environment satisfy each of the user-based condition defined in the policy based on the plurality of data streams.

7. The method of claim 1, wherein the one or more real-world conditions defined in the policy include at least one real-world requirement for immersing the user into one or more virtual environments rendered by the metaverse application.

8. The method of claim 1, wherein the one or more real-world conditions defined in the policy include:
at least one first condition defined by a provider of the metaverse application,
at least one second condition defined by an enterprise of the user, and
at least one third condition defined by a regulatory entity associated with the metaverse application.

9. The method of claim 1, wherein the one or more real-world conditions are defined in a machine-readable schema that includes one or more real-world requirement enumerations, one or more associated configuration actions, and one or more assessment timings, for installing, executing, or enabling features in the metaverse application.

10. The method of claim 1, wherein determining whether the information about the real-world environment satisfies the policy includes:
determining that the information about the real-world environment does not satisfy at least one real-world condition defined in the policy; and
selecting one or more features of the metaverse application to enable based on a number and type of the one or more real-world conditions that are satisfied.

11. An apparatus comprising:
a communication interface to enable communication with devices operating to provide a metaverse environment; and
a processor to perform operations comprising:
obtaining information about a real-world environment of a user that is interacting within a metaverse environment, wherein the information includes at least one of one or more attributes of the user in the real-world environment or one or more characteristics of a physical space of the user in the real-world environment;
determining whether the information about the real-world environment satisfies a policy associated with a metaverse application, wherein the policy defines one or more real-world conditions for the metaverse application; and
configuring the metaverse environment based on determining whether the information about the real-world environment satisfies the policy.

12. The apparatus of claim 11, wherein the processor configures the metaverse environment by:
based on determining that the information about the real-world environment satisfies each of the one or more real-world conditions defined in the policy, performing one or more of:
installing the metaverse application to render one or more virtual environments of the metaverse application,
executing the metaverse application to immerse the user within the one or more virtual environments rendered by the metaverse application, or
enabling or disabling at least one feature of the metaverse application that is configured to render the one or more virtual environments.

13. The apparatus of claim 11, wherein the information about the real-world environment is obtained by monitoring the user and the physical space that surrounds the user in the real-world environment while the user is interacting within the metaverse environment, the processor is further configured to:
based on determining that the information about the real-world environment no longer satisfies each of the one or more real-world conditions defined in the policy, reconfiguring the metaverse application by performing one or more of:
disabling a first feature of the metaverse application,
enabling a second feature of the metaverse application, or
terminating or restricting access to one or more virtual environments rendered by the metaverse application.

14. The apparatus of claim 11, wherein the processor is configured to obtain the information about the real-world environment by:
obtaining a plurality of data streams from a plurality of sensors that are configured to monitor activity of the user in the real-world environment and the physical space in which the user is interacting within the metaverse environment.

15. The apparatus of claim 14, wherein the one or more real-world conditions defined in the policy include at least one of:
an environment-based condition for the physical space including one or more of: size of the physical space, presence of one or more other users or objects in the physical space, security state of the physical space, or temperature in the physical space,
a context-based condition for the physical space, or
a user-based condition including one or more of: a physical attribute of the user, a qualification-based attribute of the user, or a co-location of the user and at least one other user of the metaverse application, wherein the physical attribute includes at least one of a physical capability of the user, a physical feature of the user, clothing worn by the user, or an equipment in the physical space.

16. The apparatus of claim 15, wherein the processor is configured to determine whether the information about the real-world environment satisfies the policy by:
determining whether the physical space of the user in the real-world environment satisfies each condition related to the physical space defined in the policy based on the plurality of data streams; and
determining whether the one or more attributes of the user in the real-world environment satisfy each of the user-based condition defined in the policy based on the plurality of data streams.

17. The apparatus of claim 11, wherein the one or more real-world conditions defined in the policy include at least one real-world requirement for immersing the user into one or more virtual environments rendered by the metaverse application.

18. One or more non-transitory computer readable storage media encoded with software comprising computer executable instructions that, when executed by a processor, cause the processor to perform a method including:
obtaining information about a real-world environment of a user that is interacting within a metaverse environment, wherein the information includes at least one of one or more attributes of the user in the real-world environment or one or more characteristics of a physical space of the user in the real-world environment;
determining whether the information about the real-world environment satisfies a policy associated with a metaverse application, wherein the policy defines one or more real-world conditions for the metaverse application; and
configuring the metaverse environment based on determining whether the information about the real-world environment satisfies the policy.

19. The one or more non-transitory computer readable storage media according to claim 18, wherein the computer executable instructions cause the processor to configure the metaverse environment by:
based on determining that the information about the real-world environment satisfies each of the one or more real-world conditions defined in the policy, performing one or more of:
installing the metaverse application to render one or more virtual environments of the metaverse application;
executing the metaverse application to immerse the user within the one or more virtual environments rendered by the metaverse application; or
enabling or disabling at least one feature of the metaverse application that is configured to render the one or more virtual environments.

20. The one or more non-transitory computer readable storage media according to claim 18, wherein the information about the real-world environment is obtained by monitoring the user and the physical space that surrounds the user in the real-world environment while the user is interacting within the metaverse environment and wherein the computer executable instructions cause the processor to perform:
based on determining that the information about the real-world environment no longer satisfies each of the one or more real-world conditions defined in the policy, reconfiguring the metaverse application by performing one or more of:
disabling a first feature of the metaverse application,
enabling a second feature of the metaverse application, or
terminating or restricting access to one or more virtual environments rendered by the metaverse application.
